(19) United States
(12) Patent Application Publication
(10) Pub. No.: US 2008/0069027 A1
(43) Pub. Date: Mar. 20, 2008

(54) Method of interference cancellation in communication systems

(76) Inventors: Hongwei Kong, Denville, NJ (US); Subramanian Vasudevan, Morristown, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/523,853

(22) Filed: Sep. 20, 2006

(51) Int. Cl. H04Q 7/00

(52) U.S. Cl. 370/328

(57) ABSTRACT

A method and apparatus thereof for processing a composite signal by removing a plurality of multipaths of one or more stealth signals from the composite signal prior to decoding one or more user signals from the composite signal. The method and apparatus being operable to decode a stealth signal from the composite signal to produce a decoded stealth signal, to generate a regenerated stealth signal using the decoded stealth signal, and to subtract a plurality of multipaths of the stealth signal from the composite signal to produce a processed composite signal using the regenerated stealth signal. The stealth signal can be any user signal to be removed from the composite signal. Preferably, the stealth signal is a scheduled data transmission of a user associated with a high received power or data rate. The plurality of multipaths may be removed from the composite signal sequentially in order of descending signal strength.

### RELATED APPLICATION

Related subject matter is disclosed in the following application and assigned to the same assignee hereof: U.S. patent application Ser. No. 10/401,594 entitled, “Method Of Interference Cancellation In Communication Systems,” inventors Subramanian Vasudevan, Hongwei Kong, Kumud K. Sanwal, Yunsong Yang, Henry Hui Ye and Jialin Zou, filed on Mar. 31, 2003.

### FIELD OF THE INVENTION

The present invention generally relates to communications systems, and more particularly to a method for canceling interference in wireless communication systems.

### DESCRIPTION OF RELATED ART

Numerous interference cancellation techniques have been proposed over the last decade for second generation and third generation wireless communication systems. Most prior art interference cancellation techniques focused on jointly decoding all user transmissions or signals at a serving base station in either a concurrent or sequential manner. One interference cancellation technique which deviated from those interference cancellation techniques was introduced in related U.S. patent application Ser. No. 10/401,594 (hereinafter referred to as “the '594 application”), which is being incorporated herein by reference.

The '594 application disclosed an interference cancellation technique that involves reducing interference by subtracting or canceling a single user signal from a composite signal before decoding all other user signals from the composite signal. The subtracted user signal, also referred to in the '594 application as a “stealth signal,” would be a scheduled data transmission with a dominate rate and received power compared to all the other user signals, wherein the other user signals may be scheduled and/or non-scheduled voice and/or data users. Subtracting the stealth signal from the composite signal involves decoding the stealth signal from the composite signal and subsequently regenerating the stealth signal. The regenerated stealth signal is then used to remove the stealth signal from the composite signal before attempting to decode any of the other user signals from the composite signal.

The composite signal, however, will most likely include multipaths of the stealth signal. The interference cancellation technique disclosed in the 594′ application does not account for multipaths when canceling the stealth signal from the composite signal. Accordingly, the removal of the stealth signal from the composite signal is inefficient or incomplete, and there exists a need for a more efficient interference cancellation technique in the presence of multipaths.

### SUMMARY OF THE INVENTION

An embodiment of the present invention is a method and apparatus thereof for processing a composite signal by removing or canceling a plurality of multipaths of one or more stealth signals from the composite signal prior to decoding one or more other user signals from the composite signal, thereby reducing overall interference to the one or more user signals being decoded. The stealth signal being a user signal to be removed from the composite signal. In an illustrative embodiment, the stealth signal is a scheduled data transmission of a user associated with a high received power or data rate. The stealth signal is decoded from the composite signal to produce a decoded stealth signal, which is used to generate a regenerated stealth signal. The regenerated stealth signal is then used to subtract a plurality of multipaths of the stealth signal from the composite signal and produce a processed composite signal from which the other user signals are decoded. The plurality of multipaths may be removed from the composite signal sequentially in order of descending signal strength.

### BRIEF DESCRIPTION OF THE DRAWINGS

The features, aspects, and advantages of the present invention will become better understood with regard to the following description, appended claims, and accompanying drawings where:

FIG. 1 depicts a wireless communication system used in accordance with the present invention;

FIG. 2 depicts a high-level block diagram illustrating a user signal transmission from a transmitter to a receiver in accordance with the present invention;

FIG. 3 depicts a block diagram of transmitter in accordance with one embodiment of the present invention;

FIG. 4 depicts a block diagram of receiver in accordance with one embodiment of the present invention;

FIG. 5 depicts a block diagram of regeneration block in accordance with one embodiment of the present invention; and

FIG. 6 depicts a flowchart illustrating a manner of processing in the cancellation block in accordance with one embodiment of the present invention.

### DETAILED DESCRIPTION

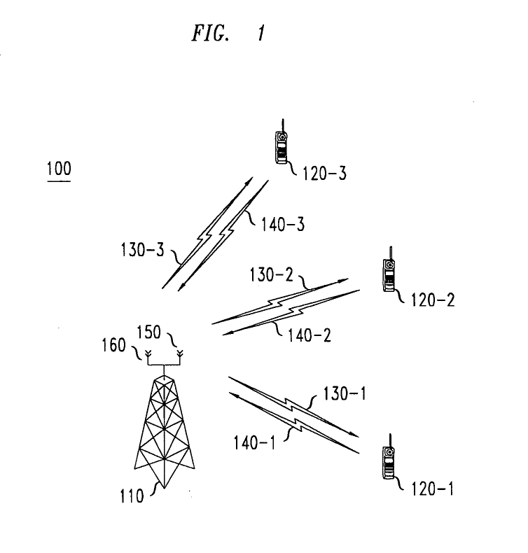

An embodiment of the present invention is a method and apparatus thereof for processing a composite signal by removing or canceling a plurality of multipaths of one or more stealth signals from the composite signal prior to decoding one or more other user signals from the composite signal, wherein the stealth signal is a user signal to be removed from the composite signal. FIG. 1 depicts a wireless communication system 100 used in accordance with one embodiment of the present invention. Wireless communication system 100 may incorporate any one of a variety of multiple access technologies including, but not limited to, the well known code division multiple access (CDMA) technology and orthogonal frequency division multiple access (OFDMA) technology.

Wireless communication system 100 includes a base station 110 and a plurality of mobile units 120-x. Base station 110 includes two antennae 150 and 160 for dual diversity reception. In other embodiments, base station 110 may include some other number of antennae. Base station 110 communicates with mobile units 120-x over forward links 130-x and reverse links 140-x. Forward links 130-x are used for transmissions from base station 110 to mobile units 120-x, whereas reverse links 140-x are used for transmissions from mobile units 120-x to base station 110.

Communication channels used for transmissions in either forward links 130-x or reverse links 140-x may include, but are not limited to, dedicated channels and shared channels. Voice and/or data may be transmitted over the dedicated channels and shared channels. With respect to data transmissions over the shared channels, such data transmissions may be scheduled or non-scheduled. Data transmissions by a mobile unit 120-x, i.e., user signal, may be scheduled by a scheduling entity. The scheduling entity may be, for example, a part of base station 110 or a radio network controller (also known as a base station controller). Scheduled data transmissions over the shared channel have associated data rates and received (or transmit) powers. The data rates and received (or transmit) powers may be determined according to factors such as channel conditions, code space availability, bandwidth availability, power availability, allowable total receive power, mobile transmit power limitations, etc.

For purposes of illustration, the present invention will be described with respect to a stealth signal being removed from a composite signal in a wireless communications network employing CDMA technology and dual diversity reception, wherein the stealth signal is a scheduled data transmission over a reverse link shared channel associated with the highest data rate and/or received power (for example, at base station 120) compared to other scheduled data transmissions on the reverse link. This should not be construed to limit the present invention in any manner. It would be apparent to one of ordinary skill in the art that the present invention would be equally applicable, for example, in wireless communication networks employing some other multiplexing technique and/or other reception technique (e.g., non-diverse or three or more diversity antennae), and for removing stealth signals on the forward link and stealth signals which are non-scheduled data transmissions.

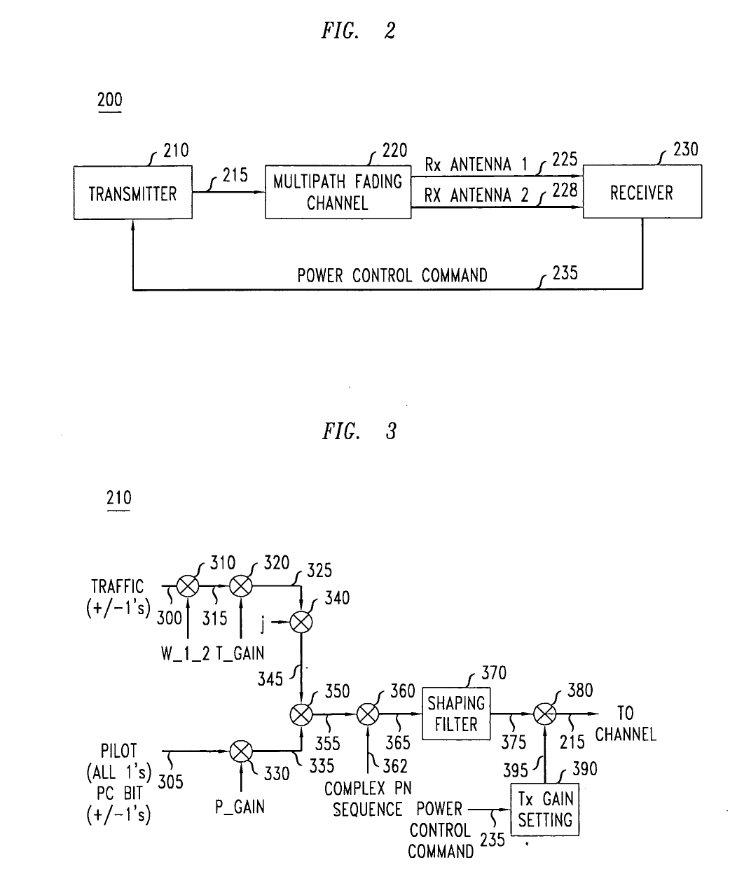

FIG. 2 depicts a high-level block diagram 200 illustrating transmission of a user signal 215 from a transmitter 210, e.g., mobile unit 120-x, to a receiver 230, e.g., base station 120, in accordance with an embodiment of the present invention. User signal 215 is transmitted over a multipath fading channel 220. Composite signals 225 and 228 are received by receiver 230 via a first and second antennae (not shown), e.g., base station antennae 150 and 160, wherein composite signals 225 and 228 include multipaths of user signal 215 and other user signals (transmitted by other transmitters, not shown). Power control commands 235 are provided to transmitter 210 by receiver 230 such that transmitter 210 may adjust its transmit power according to signal strength measurements (or some other channel quality indicator) at receiver 230.

FIG. 3 depicts a block diagram of transmitter 210 in accordance with one embodiment of the present invention. Transmitter 210 comprises a plurality of multipliers 310, 320, 330, 340, 360 and 380, a summer 350, a shaping filter 370 and a gain controller 390. Transmitter 210 is operable to process a traffic signal 300 and a control signal 305 (also referred to as a “pilot signal”). Traffic signal 300 comprises user data, whereas control signal 305 comprises pilot bits and power control bits. An orthogonal code, such as Walsh index W_1_2, is applied to traffic signal 300 by multiplier 310 to produce signal 315. A traffic gain T_Gain is applied to signal 315 by multiplier 320 to produce signal 325. A phase shift j is applied to signal 325 by multiplier 340 to produce signal 345. A pilot gain P_Gain is applied to control signal 305 by multiplier 330 to produce signal 335. Signals 345 and 335 are added together by summer 350 to produce signal 355. A pseudorandom number (PN) sequence 362 is applied to signal 355 by multiplier 360 to produce signal 365. The PN sequence may be uniquely associated with transmitter 210 or the user thereof. Signal 365 is subsequently filtered or shaped by shaping filter 370 in the frequency domain such that the bulk of the signal's energy is within a certain frequency band. Transmit gain 395 is applied to signal 375 (i.e., output of shaping filter 370) by multiplier 380 to produce user signal 215, wherein transmit gain 395 is determined by gain controller 390 in accordance with power control commands 235 sent from receiver 230.

User signal 215 is transmitted over multipath fading channel 220. Multipaths of user signal 215 are received as parts of composite signals 225 and 228 at receiver 230. Receiver 230 is operable to cancel multipaths of one or more stealth signals from a composite signal prior to decoding other user signals from the same composite signal. In one embodiment, receiver 230 detects and decodes the stealth signal from the composite signal, regenerates the stealth signal, and subtracts a plurality of stealth signal multipaths from the composite signal using the regenerated signal and information indicating locations or delays associated with the stealth signal multipaths. As mentioned earlier, the stealth signal is preferably a user signal of a scheduled data user associated with the highest received power and/or data rate relative to other scheduled data users. Due to its high received power and/or data rate, such stealth signal should be easier to decode from the composite signal relative to other user signals. The removal of this stealth signal should result in the cancellation of a large amount of interference contributed by a single user signal.

Note that receiver 230 would need to have some indication of the stealth signal's identity in order to remove its multipaths from the composite signal. Such indication may be innate if receiver 230 and scheduling entity belong to the same entity, or may be provided to receiver 230, for example, in a message.

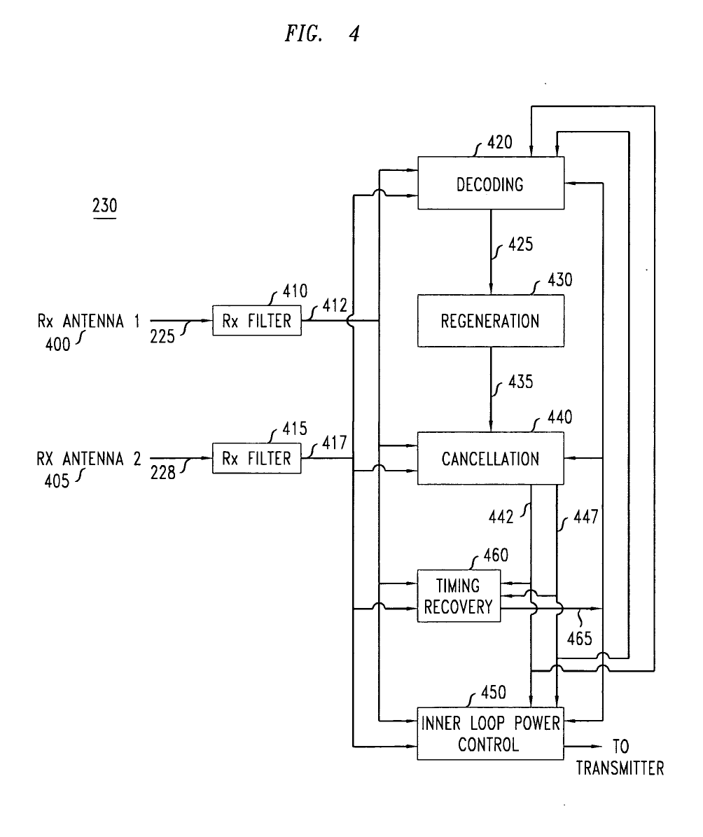

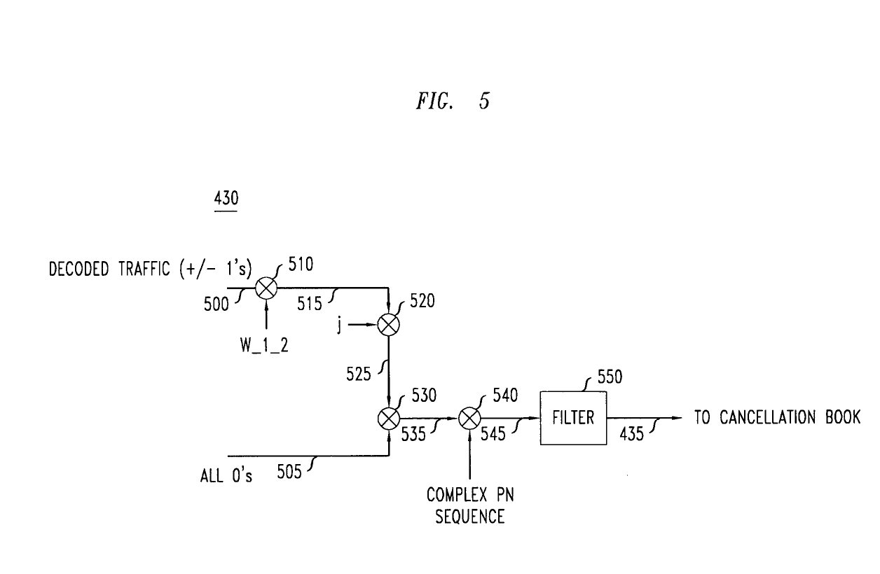

FIG. 4 depicts a block diagram of receiver 230 in accordance with one embodiment of the present invention. Receiver 230 comprises receive antennae 400 and 405, receive filters 410 and 415, a decoding block or device 420, a regeneration block or device 430, a cancellation block or device 440, an inner loop power control (ILPC) block or device 450 and a timing recovery block or device 460. Decoding block 420, regeneration block 430, cancellation block 440, inner loop power control (ILPC) block 450 and timing recovery block 460 can be implemented, for example, in an application specific integrated circuit (ASIC), field programmable gate array (FPGA) or digital signal processor (DSP).

Composite signals 225 and 228 received by antennae 400 and 405 are provided as inputs to receive filters 410 and 415 where composite signals 225 and 228 are filtered or shaped in the frequency domain to produce filtered composite signals 412 and 417. For illustration purposes, the term “composite signal” should be construed to mean the signals received by antennae 400 and 405 or their filtered versions, i.e., signals 412 and 417. Preferably, receiver filters 410 and 415 and shaping filter 370 operate to shape signals in the same frequency band. Signals 412 and 417 are subsequently provided to timing recovery block 460, decoding block 420, cancellation block 440 and ILPC block 450. In timing recovery block 460, the locations or delays associated with the one or more multipaths of one or more stealth signals, e.g., user signal 215, are determined using the control signal portions of the stealth signals. The manner in which timing recovery block 460 determines location or delays for the multipaths is well-known in the art.

The output of timing recovery block 460 is timing signal 465, which indicates the locations or delays of a group of stealth signal multipaths with respect to signals 412 and/or 417. In one embodiment, the group of multipaths may include multipaths with some minimum signal strength, multipaths within a certain delay of each other, etc. Timing signal 465 is subsequently provided as inputs to decoding block 420, cancellation block 440 and ILPC block 450.

In decoding block 420, the stealth signal is detected and decoded from composite signals 412 and 417 using timing signal 465. In one embodiment, decoding block 420 uses timing signal 465 to identify and combine multipaths of the stealth signal prior to actually decoding the stealth signal. The output of decoding block 420 is a decoded stealth signal 425 comprising of a decoded traffic signal and control signal. Decoded stealth signal 425 is then reconstructed by regeneration block 430.

FIG. 5 depicts a block diagram of regeneration block 430 in accordance with one embodiment of the present invention. Regeneration block 430 comprises multipliers 510, 520 and 540, summer 530 and filter 550. An orthogonal code, such as Walsh index W_1_2, is applied to decoded traffic signal 500 by multiplier 510 to produce signal 515. Subsequently, a phase shift j is applied to signal 515 by multiplier 520 to produce signal 525, which is then added to decoded control signal 505 by summer 530 to produce signal 535. The PN sequence associated with the transmitter (or user thereof) of the stealth signal is applied to signal 535 by multiplier 540 to produce signal 545, which is then filtered by filter 550 to produce regenerated stealth signal 435. Preferably, filter 550 and shaping filter 370 operate to shape signals in the same frequency band.

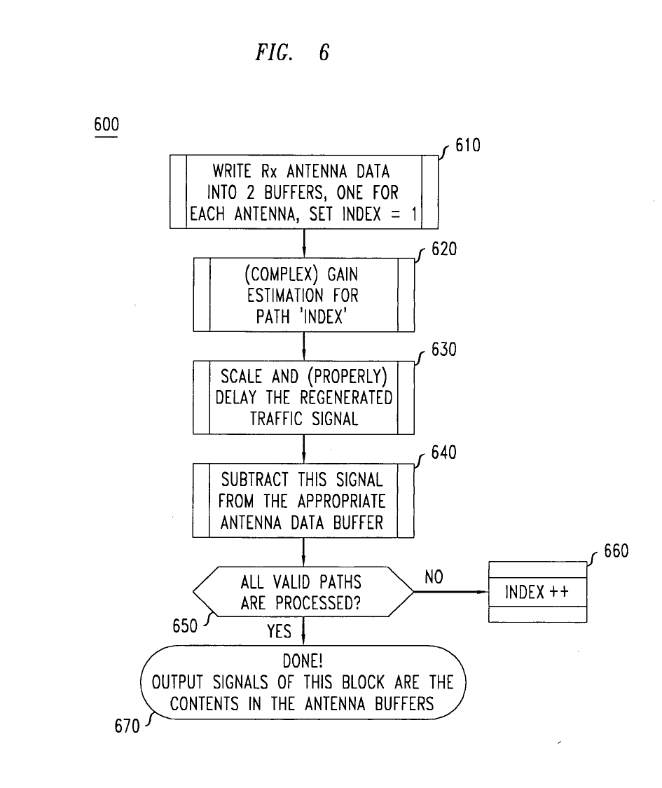

Regenerated stealth signal 435 is provided as input to cancellation block 440 where it is used to remove multipaths of the stealth signal from composite signals 412 and 417. Timing signal 465 is used by cancellation block 440 to align regenerated stealth signal 435 to the multipaths. The multipaths are removed from composite signals 412 and 417 on a path-by-path basis by cancellation block 440 for one or more paths detected by timing recovery block 460. FIG. 6 depicts a flowchart 600 illustrating a manner of processing in cancellation block 440 in accordance with one embodiment of the present invention. In step 610, signals 412 and 417 are stored in separate buffers and a path index is set to 1, wherein the path index indicates a particular multipath of the stealth signal. Each composite signal 412 and 417 stored in the buffers are subsequently processed in accordance with steps 620-670. In step 620, one or more gain values are estimated for the multipath corresponding to the path index using the regenerated signal 435. The gain estimates may be estimates for gains applied to the signals at transmitter 210 and/or receiver 230. In one embodiment, the gain values for a multipath are initially estimated by multiplying composite signals 412 and 417 by the control and/or traffic signal portion of regenerated stealth signal 435 and integrating over some duration of time, such as several power control groups (PCG) or half a PCG.

In step 630, regenerated stealth signal 435 is scaled using the gain estimates and delayed (or aligned to the multipath corresponding to the path index) using timing signal 465. In step 640, the amplified and delayed regenerated signal 435 is subtracted from the appropriate (or both) composite signal 412 and 417 to which the multipath belongs. In step 650, flowchart 600 determines whether all multipaths belonging to the group indicated by timing signal 465 have been processed. If all multipaths in the group have not been processed, then flowchart 600 continues to step 660 where the path index is increased by one before returning to step 620. Otherwise flowchart 600 continues to step 670 where subtraction of regenerated stealth signal 435 from one or both composite signals 412 and 417 is complete.

The order in which multipaths are subtracted from the stored signals 412 and 417 may impact cancellation performance. In one embodiment, the multipaths are subtracted from the composite signal in descending order of signal strength, i.e., multipath with highest signal strength measurement is subtracted from the composite signal first followed by the multipath with next highest signal strength measurement and so on.

Note that, in one embodiment, regeneration block 430 may be operable to output a composite signal comprising of a plurality of stealth signal multipaths delayed (or aligned) according to timing signal 465 and/or scaled according to gain estimates. Such composite signal can be subtracted from the appropriate (or both) composite signal in a straightforward manner, such as step 640, by cancellation block 440.

Cancellation block 440 outputs signals 442 and 447, also be referred to herein as “processed composite signals,” correspond to composite signals 412 and 417 minus the multipaths of the stealth signal. Note that signals 442 and 447 may Processed composite signals 442 and 447 are provided as inputs to ILPC block 450 and timing recovery block 460. In ILPC block 450, a power control command is determined from the total received signal to interference ratio (SIR) or some other channel quality measurement. The SIR is estimated from the pilot and power control bits in the control signal for each of the user signals being decoded. The estimated SIR is compared to a threshold SIR, and a power up or power down command is generated based on the result of the comparison. For example, a power up command is generated if the estimated SIR is lower than the threshold SIR. Otherwise a power down command is generated.

Note that the SIR can be estimated from signals 412, 417, 442 and/or 447. In one embodiment, ILPC block 450 uses timing signal 465 to align the multipaths such that the signal strengths of the multipaths may be added together. The resulting sum, i.e., estimated SIR, is compared to the threshold SIR. In timing recovery block 460, signals 442 and 447 or composite signals 412 and 417 may be used to determine location or delays of other user signals to be decoded or other stealth signals to be canceled.

After the stealth signal has been canceled, other stealth signals may also be canceled from composite signals 442 and 447 prior to decoding other user signals thereby further improving the SIR of the user signals to be decoded. For example, the user signal associated with the next highest transmit rate and/or power is canceled from composite signals 442 and 447 before decoding other user signals. If cancellation of stealth signals have been completed, then decoding device 420 or another decoding device, not shown, may decode other user signals from the output of cancellation device 440.

Although the present invention has been described in considerable detail with reference to certain embodiments, other versions are possible. Therefore, the spirit and scope of the present invention should not be limited to the description of the embodiments contained herein.

1. A method of processing a composite signal comprising the steps of:
decoding a stealth signal from the composite signal to produce a decoded stealth signal;
generating a regenerated stealth signal using the decoded stealth signal; and
subtracting a plurality of multipaths of the stealth signal from the composite signal to produce a processed composite signal using the regenerated stealth signal.

2. The method of claim 1, wherein the plurality of multipaths is subtracted from the composite signal using a timing signal indicative of locations or delays associated with the plurality of multipaths.

3. The method of claim 1, wherein the regenerated stealth signal is scaled using an estimated gain value prior to the step of subtracting the plurality of multipaths.

4. The method of claim 1, wherein the gain value is estimated using a traffic signal portion of the regenerated stealth signal.

5. The method of claim 1, wherein the plurality of multipaths is sequentially subtracted from the composite signal in order of descending signal strength using the regenerated stealth signal.

6. The method of claim 1, wherein the regenerated stealth signal is a composite signal comprising of a plurality of multipaths aligned based on a timing signal, the timing signal being indicative of locations or delays associated with the plurality of multipaths.

7. The method of claim 1, wherein the plurality of multipaths of the stealth signal have a signal strength at or above a threshold value.

8. The method of claim 1, wherein the stealth signal is a data transmission.

9. The method of claim 8, wherein the data transmission is a scheduled data transmission associated with a high received power and/or data rate relative to other data transmissions.

10. The method of claim 1, wherein the stealth signal is decoded from the composite signal using a timing signal indicative of locations or delays associated with the plurality of multipaths.

11. The method of claim 1 comprising the additional step of:
subtracting one or more multipaths of another stealth signal from the processed composite signal.

12. A receiver for processing a composite signal comprising:
a decoding device for decoding a stealth signal from the composite signal to produce a decoded stealth signal;
a regeneration device for generating a regenerated stealth signal using the decoded stealth signal; and
a cancellation device for subtracting a plurality of multipaths of the stealth signal from the composite signal to produce a processed composite signal using the regenerated stealth signal.

13. The receiver of claim 12 further comprising:
a timing recovery device for generating a timing signal indicative of locations or delays associated with the plurality of multipaths.

14. The receiver of claim 13, wherein the timing signal is provided to the decoding device for identifying multipaths of the stealth signal.

15. The receiver of claim 13, wherein the timing signal is provided to the cancellation device for aligning the regenerated stealth signal to each of the plurality of multipaths.

16. The receiver of claim 13, wherein the timing signal is provided to the regeneration device for generating a regenerated stealth signal comprising of a plurality of multipaths aligned based on the timing signal.

17. The receiver of claim 12, wherein the decoding device is further operable to decode another stealth signal or a user signal from the processed composite signal.
